(19) United States
(12) Patent Application Publication
(10) Pub. No.: US 2012/0163370 A1
(43) Pub. Date: Jun. 28, 2012

(54) VOIP PHONE READINESS ALERTING

(75) Inventors: Gustavo Fiorante, Sao Paulo (BR); Pablo R. M. Gonzalez, Sao Paulo (BR); Kusuma Govindaraju, Sao Paulo (BR); Luiz G. Polacchini Nazareth, Sao Paulo (BR)

(73) Assignee: INTERNATIONAL BUSINESS MACHINES CORPORATION, Armonk, NY (US)

(21) Appl. No.: 12/980,067

(22) Filed: Dec. 28, 2010

(51) Int. Cl. H04L 12/66

(52) U.S. Cl. 370/352

(57) ABSTRACT

Readiness alerts are provided for callers using Voice Over Internet Protocol (“VoIP”) phones. When the call is placed on hold by the called party, for example to play a stream of music or recorded messages, the caller no longer has to remain attentive in order to detect when the call is answered by a human being. Instead, an agent monitors for the call to be answered. When this is detected, a readiness alert or alerts is/are sent to the calling party. In one approach, a visual message is displayed on a computing device of the calling party. In addition or instead, an audible message is rendered from the computing device. In another approach, the call is automatically forwarded to a mobile device or alternatively, to a different phone, at which the calling party is reachable.

### BACKGROUND

The present invention relates to computing and telephones, and deals more particularly with providing readiness alerts for callers using Voice Over Internet Protocol (“VoIP”) phones.

Today, when a person places a call to a support center of some type, it may take a considerable amount of time before the incoming call is routed to a customer support agent. Examples of this type of support center include credit card customer support, customer support provided by an online shopping company, a consumer support center provided by a corporation, and consumer support provided by governmental agencies. Sometimes when calling such a support center, an automated function informs the caller of the expected wait time. Other times, the caller waits without knowing the expected wait time. In either case, the wait time can be 15 minutes or more when calling a busy support center. This delay can result in an inefficient, time-consuming, and frustrating experience for the caller, who often has other things that he or she could be doing.

### BRIEF SUMMARY

The present invention is directed to VoIP phone readiness alerting. In one aspect, this comprises: identifying, at a calling party, when a message received from a called party indicates that a call from the calling party to the called party is answered by the called party; and responsive to the identifying, causing a readiness alert to be provided to the calling party to indicate that the call is ready for a conversation between the calling party and the called party. Preferably, a phone of the calling party is a VoIP phone (and a phone of the called party may also be a VoIP phone). The identifying and the causing a readiness alert are preferably performed by software installed at a computing device which is operably connected to a phone of the calling party. In one aspect, the readiness alert comprises at least one of: a visual alert and an audible alert. In another aspect, the readiness alert comprises automatically forwarding the call to a different phone of the calling party (for example, to a mobile device at which the calling party is reachable).

Embodiments of these and other aspects of the present invention may be provided as methods, systems, and/or computer program products. It should be noted that the foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined by the appended claims, will become apparent in the non-limiting detailed description set forth below.

### BRIEF DESCRIPTION OF THE SEVERAL VIEWS OF THE DRAWINGS

The present invention will be described with reference to the following drawings, in which like reference numbers denote the same element throughout.

FIG. 1 illustrates an example of establishing a telephone call between two parties, according to the prior art;

FIG. 2 illustrates how the components of FIG. 1 may be augmented, according to an embodiment of the present invention;

FIG. 3 illustrates how an embodiment of the present invention may notify a calling party of readiness of the called party, according to an embodiment of the present invention;

FIG. 4 illustrates a sample data structure which may be used for storing information used by an embodiment of the present invention;

FIG. 5 depicts a data processing system suitable for storing and/or executing program code; and

FIG. 6 depicts a representative networking environment in which one or more embodiments of the present invention may be used.

### DETAILED DESCRIPTION

An embodiment of the present invention provides readiness alerting for a caller, who is also referred to herein as a “calling party”. When using known techniques, a caller who calls a busy support center and is placed on hold typically has to be attentive, at least to some degree, to the on-hold call in order to detect when the call is taken off hold for handling by a call support agent. The caller may detect this, when using existing techniques, by listening for a signal that the call has been answered by a human being at the called party phone number. Typically, this signal comprises the on-hold music stream being replaced by the voice of a human being at the called party phone number, or messages from a recorded human voice being replaced by the voice of the human being. According to an embodiment of the present invention, by contrast, the caller does not need to remain attentive while waiting for this audible signal. Instead, in one embodiment, an alert will be automatically provided to the caller when the call is answered—that is, when the call is taken off hold for handling by a call support agent (or similar personnel). In another embodiment, the call is automatically forwarded to a mobile device of the caller when the call is answered. Therefore, a caller using an embodiment of the present invention can continue his or her work in the interim, and avoids wasting time by attentively listening on the phone to hear the call support agent's voice.

Some callers do not enjoy the typical on-hold music (or other audio stream) provided to them while their call is on hold. Accordingly, an added benefit of the present invention is that the callers do not have to listen to this music or audio at all, and instead can concentrate on something else—such as a work assignment—while waiting for the called party to answer the call.

An embodiment of the present invention preferably leverages existing communication technology for the pipeline for the telephone call between the calling party and the called party. (Alternatively, an embodiment of the present invention may be used with communication technology which is not yet invented.) Examples of such existing communication technology include the so-called H.323 protocol or the Session Initiation Protocol. H.323 is a Recommendation from the Telecommunication Standardization Sector of the International Telecommunication Union (ITU). The Session Initiation Protocol, which is commonly referred to as “SIP”, is described in Request for Comments (RFC) 3261 from the Internet Engineering Task Force, which is titled “SIP: Session Initiation Protocol”. Discussions of the present invention are presented herein with reference to Session Initiation Protocol, by way of illustration but not of limitation. Specific details of existing SIP processing which are not necessary to an understanding of the present invention are omitted herein.

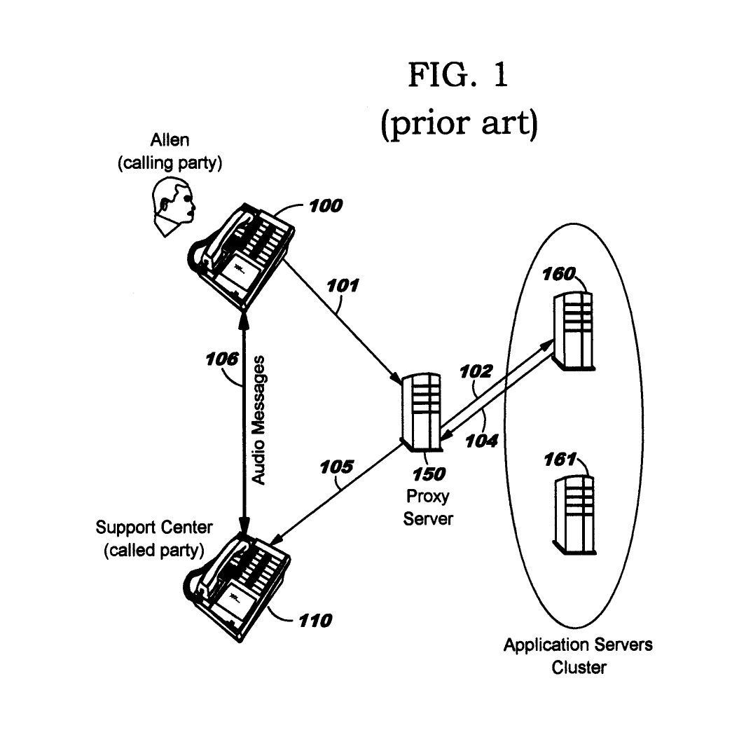

FIG. 1 illustrates an example of establishing a telephone call between two parties when using SIP, according to the prior art. In this illustrated example, the calling party is a person named Allen (see the calling party's device 100) and the called party is a support center (see the called party's device 110). Conventional SIP techniques may be used for establishing this phone call, as will now be briefly described. A conventional SIP environment includes a proxy server (see reference number 150) and one or more application servers (see reference numbers 160, 161) which may be organized as an application server cluster. In this example, Allen initiates the call by sending a SIP INVITE request message (see reference number 101) from a user agent executing on his behalf to the proxy server 150. (Note that the user agent for the SIP call participants may be software executing on their respective computing devices. Because this user agent provides calling services, it is also referred to and illustrated herein as a telephone. The term “softphone” is sometimes used when referring to the SIP user agent client which runs on a personal computer or laptop which enables the user's telephone call connection.) According to the SIP protocol, the proxy server 150 is responsible for various call routing functions. The proxy server forwards the SIP INVITE request 101 to application server 160 (see reference number 102).

In this example of FIG. 1, the application server 160 forwards 104 the INVITE request to the proxy server 150, which routes it 105 to the user agent representing a telephone number at the support center. (Note that the application server may directly contact the called party without going through the proxy server, although this has not been illustrated in FIG. 1.) When the support center answers the incoming call, whether by a human being or by an automated call answering function, a call is established over a communications pipeline between Allen and the support center (see reference number 106), and audio messages may then begin to be transmitted on this call. The audio messages may comprise human beings speaking to one another, if the call is answered by a human being. Alternatively, when the call is answered by an automated call answering function, then the audio messages typically comprise music or other recorded information from the call center.

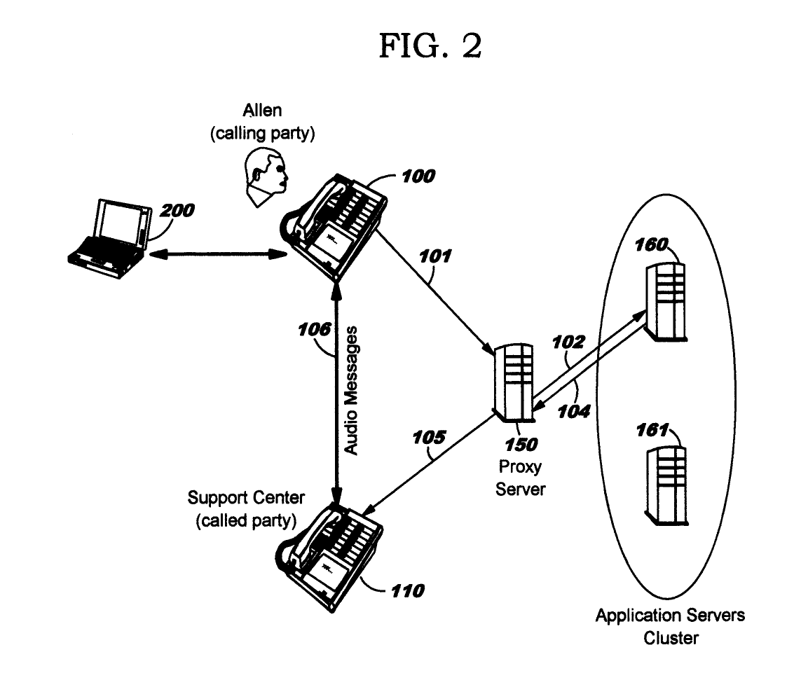

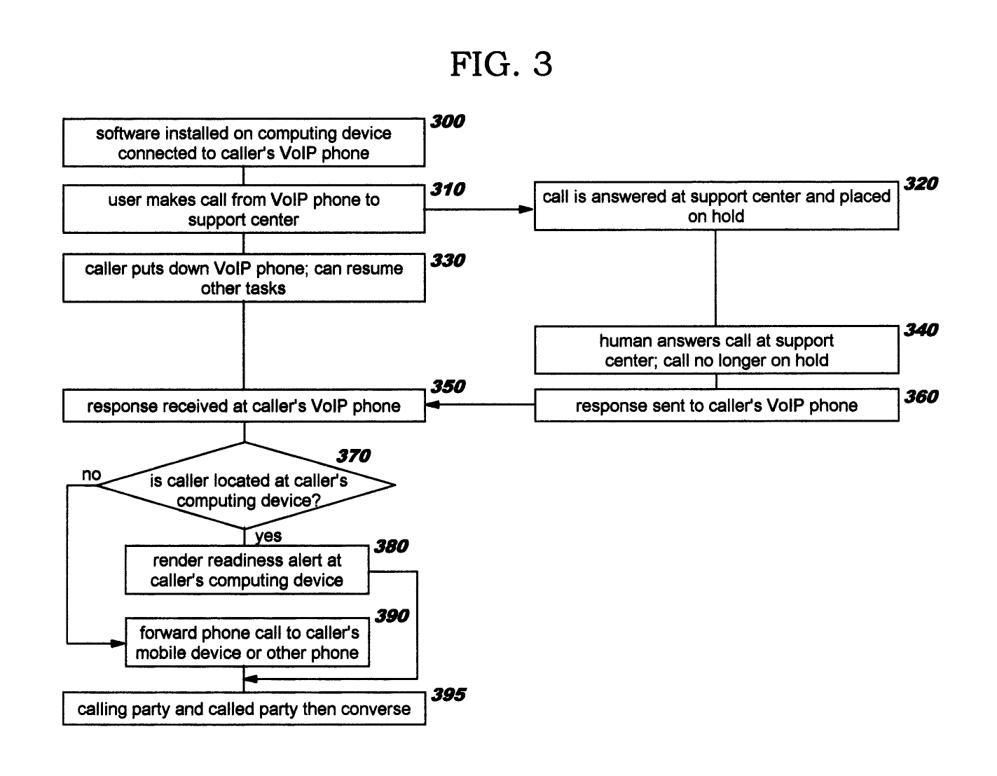

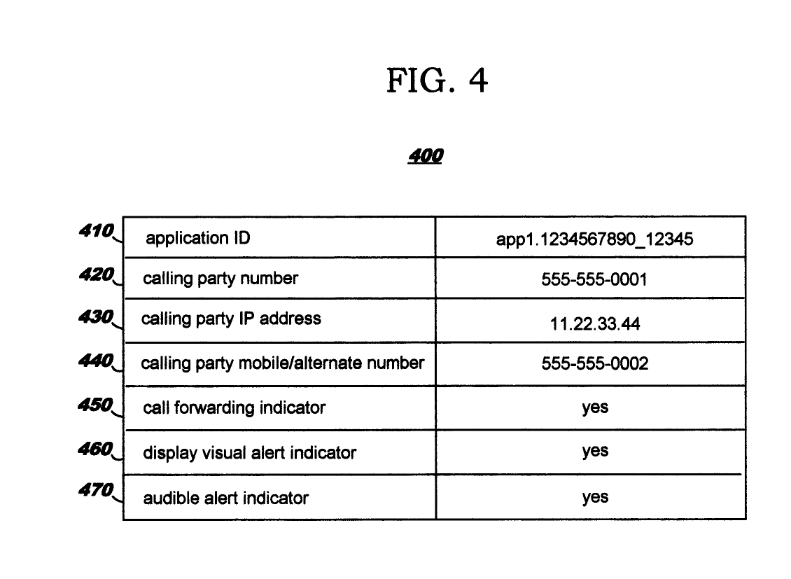

FIG. 2 illustrates how the components of FIG. 1 may be augmented, according to an embodiment of the present invention. A laptop computer 200 or other device capable of executing software is operably connected (by physical means and/or by communication means) to the telephone device 100 of the calling party. This computer 200 has software installed for receiving incoming messages, evaluating the incoming messages, and alerting the caller, as will be described in more detail below with reference to FIGS. 3 and 4. The calling party's telephone device 100 and the called party's telephone device 110 are preferably VoIP phones; accordingly, devices 100 and 110 are referred to hereinafter as VoIP phones. Notably, these VoIP phones 100, 110 may use existing VoIP technology. It should also be noted that no changes are required to the called party environment when using preferred embodiments of the present invention.

FIG. 3 illustrates how an embodiment of the present invention may notify a calling party of readiness of the called party. As shown therein, readiness alerting software that supports an embodiment of the present invention by receiving a notification, evaluating the notification, and providing a readiness alert to the caller is installed (Block 300) on a computing device (see 200 of FIG. 2) that is operably connected to the caller's VoIP phone (see 100 of FIG. 2). This software may be structured as an agent function that monitors incoming call messages. (Note that while discussions herein refer to the readiness alerting as being provided by software, this is by way of illustration and not of limitation.)

At some point following the software installation at Block 300, the user of VoIP phone 100 makes a phone call to a support center (Block 310). The call is answered at the support center (Block 320), typically by an automated means, and placed in an on-hold mode. While the call remains in this on-hold mode, the support center may play a recorded music stream or other recorded audio stream over the communications pipeline (see 106 of FIG. 2).

The calling party, when using an embodiment of the present invention, does not need to listen attentively to the music or other audio stream which is being played by the support center while the call remains on hold. Accordingly, the calling party 100 can put down the VoIP phone and resume working (Block 330) or other tasks.

At some point, a human being answers the phone call at the support center, which takes the call out of the on-hold mode (Block 340). This may be detected by a conventional multi-line business telephone system, which is sometimes referred to as a private automatic branch exchange or PABX, using existing techniques of such systems. In one alternative, a voice recognition algorithm may be used for detecting that a human being is now speaking, rather than the recorded music or audio stream. Voice recognition algorithms are well known in the art, and details of such processing are not deemed necessary to an understanding of the present invention and are therefore omitted herein. One example of such voice recognition algorithm is provided in the IBM ViaVoice® software product, which is available from IBM Corporation. (“ViaVoice” is a registered trademark of International Business Machines Corporation, or “IBM”, in the United States, other countries, or both.) Responsive to detecting that the human being is now speaking, the communication technology at the support center sends a response message to the calling party's VoIP phone (Block 360).

The response message from the support center is received at the calling party's VoIP phone (Block 350). Because the computing device 200 is operably attached to the calling party's VoIP phone, the computing device 200 also receives this response message. The software installed at Block 300 therefore evaluates this response message, and upon determining that the on-hold call has now been taken off hold, the software generates a readiness notification that notifies the calling party that the call is now ready. The software at computing device 200 may determine that the call has been taken off hold by virtue of a particular message type sent at Block 360, in one approach. In another approach, the software at computing device 200 may use voice recognition processing to differentiate between the music or audio stream that had been playing and the voice of the human being that is now being transmitted over the communications pipeline.

In one approach, the readiness notification processing performed at computing device 200 comprises determining whether the caller is present at computing device 200 (Block 370). If so, then a readiness alert is rendered at the computing device (Block 380). This may comprise a visual rendering and/or an audible rendering. For example, a visual message may be displayed on the graphical user interface of computing device 200, where that visual message includes content such as “Incoming call!!” or “Your phone call to the support center is now ready”. An audible message with similar content may be played from computing device 200 in addition to, or instead of, displaying a visual message.

If the test at Block 370 indicates that the caller is not present at computing device 200, on the other hand, then stored configuration data may be consulted to determine how to contact the caller at a mobile device, and the original phone call may then be transferred to this mobile device (Block 390). The mobile device may be a cell phone, for example. Existing techniques for call forwarding are preferably leveraged at Block 390 for transferring the phone call from the calling party's VoIP phone 100 to the calling party's mobile device. (Because existing call forwarding techniques are preferably leveraged, details of this call forwarding processing are not deemed necessary to an understanding of the present invention and are not illustrated or described further herein.)

Several alternatives may be used for the readiness processing described at Block 390. As an alternative to transferring the call to a mobile device using call forwarding, the call may be forwarded to a different phone number or phone extension (i.e., to a phone number or extension other than the one to which VoIP phone 100 is connected). For example, if the caller has to wait for a long time for the call to be answered, the caller might need to move to a different office location—perhaps, by way of example, to a conference room for attending a meeting. Using an embodiment of the present invention, the call can be automatically transferred at Block 390 to a phone where the caller is now located.

When the caller has to leave the location of the VoIP phone 100 used for the originally-placed call, the automatic call transfer which may be provided at Block 390 when using an embodiment of the present invention avoids having to hang up the original on-hold call and initiate a new call to the support center from the caller's moved-to location, and the caller therefore does not have to lose his or her place in a queue of waiting callers.

Upon receiving the readiness notification by either the processing of Block 380 or the processing of Block 390, the calling party can then continue with the phone call to the support center (Block 395). As noted above, this may comprise continuing the phone call at the caller's VoIP phone 100, at the caller's mobile device, or at another phone number which may have been designated by the caller. Notably, even though the call may have been transferred to a device other than the VoIP phone 100, the calling party and called party can converse without disruption to the call.

FIG. 4 illustrates a sample data structure 400, comprising sample fields and sample values, which may be used for storing information used by an embodiment of the present invention. As shown therein, information which may be stored for use by the calling party's computing device 200 comprises an application identifier 410; the phone number 420 of the calling party; the IP address 430 of the calling party; a contact number 440 for a mobile device or for an alternative calling party phone; a call forwarding indicator 450; a display visual alert indicator 460; and an audible alert indicator 470. Notably, an embodiment of the present invention does not require the support center to maintain this type of information, as the readiness alerting is preferably deployed at the calling party as has been described above.

The information illustrated at 400 of FIG. 4 will now be discussed in more detail. Application identifier 410 preferably identifies the application which supports the communications pipeline between the calling party and the called party. This application identifier may be used, for example, when multiple people share a computer and VoIP phone. In this case, each person may log into an application using his or her distinct logon information, which identifies a distinct user profile. The user profile may contain various user-specific information. Phone number 420 preferably identifies the VoIP phone of the calling party, and IP address 430 preferably identifies a connection to the communication device 200 of the calling party. Contact number 440 preferably identifies a phone number for a mobile device at which the caller can be reached, or an alternative phone at which the calling party can be reached (as discussed above with reference to Block 390). Call forwarding indicator 450 is preferably a Boolean or yes/no value which indicates whether calls should be forwarded for this calling party. Display visual alert indicator 460 and audible alert indicator 470 are preferably Booleans or yes/no values which indicate whether this calling party wishes to receive readiness notifications by visual or audible messages, respectively. Alternatively, the value for field 460 and/or field 470 may comprise a file name for a file that stores a visual or audible message, respectively, to be rendered to the user as the readiness alert. (As illustrated by the sample values for fields 460 and 470, the visual and audible alerts are not mutually exclusive.)

A configuration interface may be provided for software that operates on computing device 200 to provide readiness alerting. This configuration interface may enable a user to supply values for one or more of the fields illustrated in table 400.

Embodiments of the present invention may enable callers to make more productive use of their time, due to obviating the need to remain attentive to an on-hold call. While preferred embodiments have been described with reference to placing calls to support centers, this is by way of illustration and not of limitation, and the disclosed techniques may be used without regard to the type of entity at the called party phone number. As has been noted above, existing VoIP phones may be used, and embodiments of the present invention therefore do not require a specially-configured or specially-adapted phone. As also noted above, embodiments of the present invention use functionality on the calling party side, and therefore may be provided without regard to whether the calling and/or called party subscribes to a particular service.

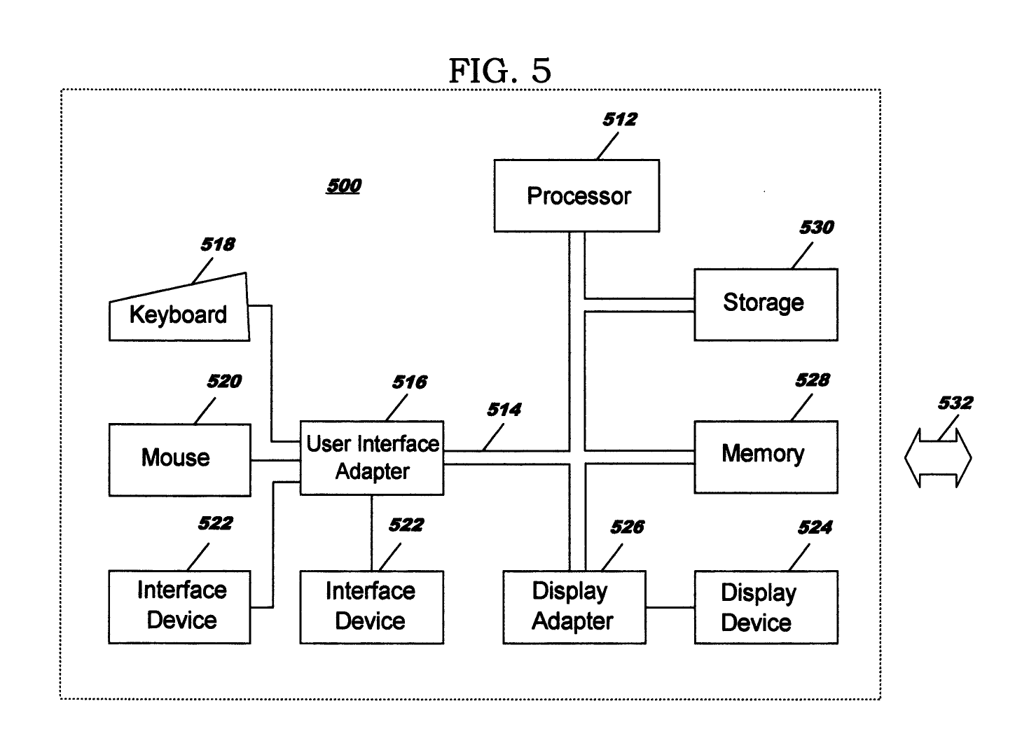

Referring now to FIG. 5, a data processing system 500 suitable for storing and/or executing program code includes at least one processor 512 coupled directly or indirectly to memory elements through a system bus 514. The memory elements can include local memory 528 employed during actual execution of the program code, bulk storage 530, and cache memories (not shown) which provide temporary storage of at least some program code in order to reduce the number of times code must be retrieved from bulk storage during execution.

Input/output (“I/O”) devices (including but not limited to keyboards 518, displays 524, pointing devices 520, other interface devices 522, etc.) can be coupled to the system either directly or through intervening I/O controllers or adapters (516, 526).

Network adapters may also be coupled to the system to enable the data processing system to become coupled to other data processing systems or remote printers or storage devices through intervening private or public networks (as shown generally at 532). Modems, cable modem attachments, wireless adapters, and Ethernet cards are just a few of the currently-available types of network adapters.

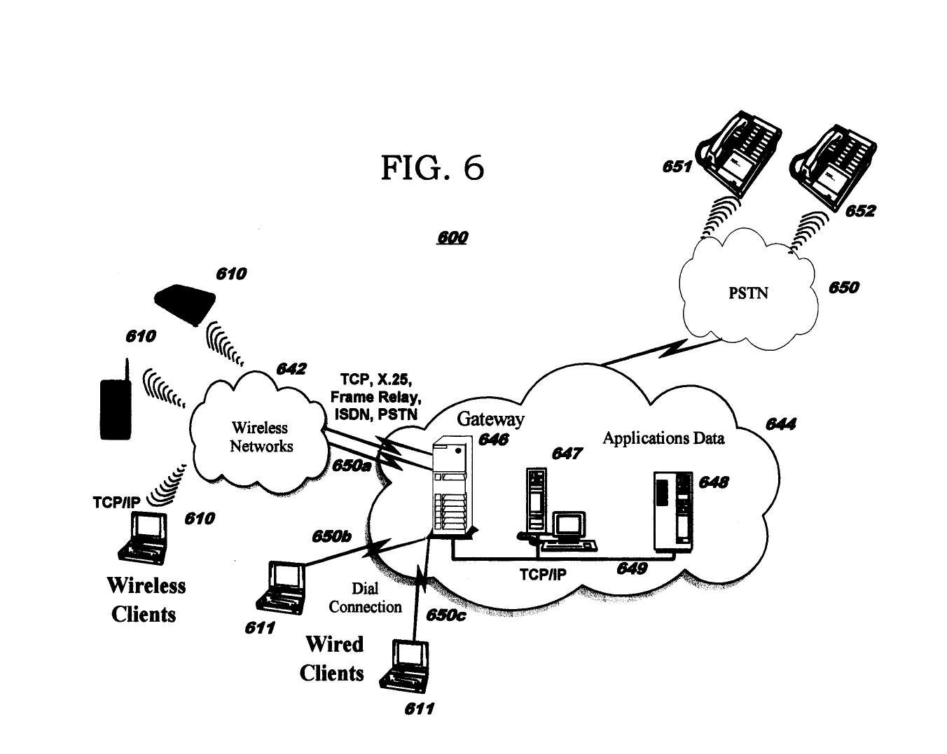

FIG. 6 illustrates a data processing network environment 600 in which the present invention may be practiced. The data processing network 600 may include a plurality of individual networks, such as wireless network 642 and wired network 644. A plurality of wireless devices 610 may communicate over wireless network 642, and a plurality of wired devices, shown in the figure (by way of illustration) as workstations 611, may communicate over network 644. Additionally, as those skilled in the art will appreciate, one or more local area networks (“LANs”) may be included (not shown), where a LAN may comprise a plurality of devices coupled to a host processor. A public switched telephone network (“PSTN”) 650 may be connected to wired network 644, and a plurality of telephones 651, 652 may be connected to the PSTN 650.

Still referring to FIG. 6, the networks 642 and 644 may also include mainframe computers or servers, such as a gateway computer 646 or application server 647 (which may access a data repository 648). A gateway computer 646 serves as a point of entry into each network, such as network 644. The gateway 646 may be preferably coupled to another network 642 by means of a communications link 650a. The gateway 646 may also be directly coupled to one or more workstations 611 using a communications link 650b, 650c, and/or may be indirectly coupled to such devices. The gateway computer 646 may be implemented utilizing an Enterprise Systems Architecture/390® computer available from IBM. Depending on the application, a midrange computer, such as an iSeries®, System i™, and so forth may be employed. (“Enterprise Systems Architecture/390” and “iSeries” are registered trademarks of IBM in the United States, other countries, or both, and “System i” is a trademark of IBM.)

The gateway computer 646 may also be coupled 649 to a storage device (such as data repository 648).

Those skilled in the art will appreciate that the gateway computer 646 may be located a great geographic distance from the network 642, and similarly, the workstations 611 may be located some distance from the networks 642 and 644, respectively. For example, the network 642 may be located in California, while the gateway 646 may be located in Texas, and one or more of the workstations 611 may be located in Florida. The workstations 611 may connect to the wireless network 642 using a networking protocol such as the Transmission Control Protocol/Internet Protocol (“TCP/IP”) over a number of alternative connection media, such as cellular phone, radio frequency networks, satellite networks, etc. The wireless network 642 preferably connects to the gateway 646 using a network connection 650a such as TCP or User Datagram Protocol (“UDP”) over IP, X.25, Frame Relay, Integrated Services Digital Network (“ISDN”), Public Switched Telephone Network (“PSTN”), etc. The workstations 611 may connect directly to the gateway 646 using dial connections 650b or 650c. Further, the wireless network 642 and network 644 may connect to one or more other networks (not shown), in an analogous manner to that depicted in FIG. 6.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit”, “module”, or “system”. Furthermore, aspects of the present invention may take the form of a computer program product embodied in one or more computer readable media having computer readable program code embodied thereon.

Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (“RAM”), a read-only memory (“ROM”), an erasable programmable read-only memory (“EPROM” or flash memory), a portable compact disc read-only memory (“CD-ROM”), DVD, an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency, etc., or any suitable combination of the foregoing.

Computer program code for carrying out operations for aspects of the present invention may be written in any combination of one or more programming languages, including an object oriented programming language such as Java, Smalltalk, C++, or the like, and conventional procedural programming languages such as the “C” programming language or similar programming languages. The program code may execute as a stand-alone software package, and may execute partly on a user's computing device and partly on a remote computer. The remote computer may be connected to the user's computing device through any type of network, including a local area network (“LAN”), a wide area network (“WAN”), or through the Internet using an Internet Service Provider.

Aspects of the present invention are described above with reference to flow diagrams and/or block diagrams of methods, apparatus (systems), and computer program products according to embodiments of the invention. It will be understood that each flow or block of the flow diagrams and/or block diagrams, and combinations of flows or blocks in the flow diagrams and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow diagram flow or flows and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flow diagram flow or flows and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flow diagram flow or flows and/or block diagram block or blocks.

Flow diagrams and/or block diagrams presented in the figures herein illustrate the architecture, functionality, and operation of possible implementations of systems, methods, and computer program products according to various embodiments of the present invention. In this regard, each flow or block in the flow diagrams or block diagrams may represent a module, segment, or portion of code, which comprises one or more executable instructions for implementing the specified logical function(s). It should also be noted that, in some alternative implementations, the functions noted in the flows and/or blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or each flow of the flow diagrams, and combinations of blocks in the block diagrams and/or flows in the flow diagrams, may be implemented by special purpose hardware-based systems that perform the specified functions or acts, or combinations of special purpose hardware and computer instructions.

While embodiments of the present invention have been described, additional variations and modifications in those embodiments may occur to those skilled in the art once they learn of the basic inventive concepts. Therefore, it is intended that the appended claims shall be construed to include the described embodiments and all such variations and modifications as fall within the spirit and scope of the invention.

1. A computer-implemented method of providing phone readiness alerting, comprising:
identifying, at a calling party, when a message received from a called party indicates that a call from the calling party to the called party is answered by the called party; and
responsive to the identifying, causing a readiness alert to be provided to the calling party to indicate that the call is ready for a conversation between the calling party and the called party.

2. The method according to claim 1, wherein a phone of the calling party is a Voice Over Internet Protocol (“VoIP”) phone.

3. The method according to claim 1, wherein the identifying and the causing a readiness alert are performed by software installed at a computing device which is operably connected to a phone of the calling party.

4. The method according to claim 1, wherein the readiness alert comprises at least one of: a visual alert and an audible alert.

5. The method according to claim 1, wherein the readiness alert comprises a message rendered by a computing device of the calling party.

6. The method according to claim 5, wherein the message is rendered by the computing device only if the calling party is determined to be present at the computing device.

7. The method according to claim 1, wherein the readiness alert comprises automatically forwarding the call to a different phone of the calling party.

8. The method according to claim 7, wherein the different phone of the calling party is a mobile device at which the calling party is reachable.

9. The method according to claim 8, wherein a phone number of the mobile device is determined from stored configuration information associated with the calling party.

10. The method according to claim 7, wherein the different phone of the calling party is a different phone number at which the calling party is reachable.

11. The method according to claim 10, wherein the different phone number is determined from stored configuration information associated with the calling party.

12. The method according to claim 7, wherein the automatically forwarding transfers the call without disruption.

13. A system for providing phone readiness alerting, comprising:
a computer comprising a processor; and
instructions which are executable, using the processor, to implement functions comprising:
identifying, at a calling party, when a message received from a called party indicates that a call from the calling party to the called party is answered by the called party; and
responsive to the identifying, causing a readiness alert to be provided to the calling party to indicate that the call is ready for a conversation between the calling party and the called party.

14. The system according to claim 13, wherein a phone of the calling party is a Voice Over Internet Protocol (“VoIP”) phone.

15. The system according to claim 13, wherein:
the computer is operably connected to a phone of the calling party; and
causing the readiness alert to be provided further comprises causing rendering, if the calling party is determined to be present at the computer, by the computer of at least one of: a visual alert and an audible alert.

16. The system according to claim 13, wherein causing the readiness alert to be provided comprises automatically forwarding the call, without disruption of the call, to a different phone of the calling party, using a phone number determined from stored configuration data which is associated with the calling party.

17. A computer program product for providing phone readiness alerting, the computer program product comprising:
a computer readable storage medium having computer readable program code embodied therein, the computer readable program code configured for:
identifying, at a calling party, when a message received from a called party indicates that a call from the calling party to the called party is answered by the called party; and
responsive to the identifying, causing a readiness alert to be provided to the calling party to indicate that the call is ready for a conversation between the calling party and the called party.

18. The computer program product according to claim 17, wherein a phone of the calling party is a Voice Over Internet Protocol (“VoIP”) phone.

19. The computer program product according to claim 17, wherein the readiness alert comprises at least one of: a visual alert and an audible alert.

20. The computer program product according to claim 17, wherein causing the readiness alert to be provided comprises automatically forwarding the call, without disruption of the call, to a different phone of the calling party, using a phone number determined from stored configuration data which is associated with the calling party.
